(19) United States
(12) Patent Application Publication
(10) Pub. No.: US 2017/0167274 A1
(43) Pub. Date: Jun. 15, 2017

(54) ARTICLE AND METHOD OF FORMING AN ARTICLE

(71) Applicant: GENERAL ELECTRIC COMPANY, Schenectady, NY (US)

(72) Inventor: Gary Michael ITZEL, Simpsonville, SC (US)

(21) Appl. No.: 14/963,801

(22) Filed: Dec. 9, 2015

(51) Int. Cl. F01D 5/18; B33Y 80/00; B23K 26/342; F01D 25/12; B22F 3/105; B22F 5/04; F01D 9/04; B33Y 10/00; B23K 15/00

(52) U.S. Cl. CPC F01D 5/189; B33Y 10/00; B33Y 80/00; B23K 26/342; B23K 15/0086; B22F 3/1055; B22F 5/04; F01D 9/041; F01D 25/12; B23K 2201/001

(57) ABSTRACT

An article and method of cooling an article are provided. The article includes a body portion having an inner surface and an outer surface, the inner surface defining an inner region, and at least one cooling feature positioned within the inner region. At least one of the inner surface of the body portion and the at least one cooling feature has a surface roughness of between about 100 microinches (about 2.54 microns) and about 3,000 microinches (about 76.2 microns). The method of forming an article includes manufacturing a body portion by an additive manufacturing technique, and manufacturing at least one cooling feature by the additive manufacturing technique. The additive manufacturing integrally forms a surface roughness of between about 100 microinches (about 2.54 microns) and about 3,000 microinches (about 76.2 microns) on at least one of an inner surface of the body portion and the at least one cooling feature.

### FIELD OF THE INVENTION

The present invention is directed to an article and a method of forming an article. More particularly, the present invention is directed to a cooled article and a method of forming a cooled article.

### BACKGROUND OF THE INVENTION

Turbine systems are continuously being modified to increase efficiency and decrease cost. One method for increasing the efficiency of a turbine system includes increasing the operating temperature of the turbine system. To increase the temperature, the turbine system must be constructed of materials which can withstand such temperatures during continued use.

One common method of increasing a temperature capability of a turbine component includes the use of cooling features. The cooling features are often formed from metals and alloys used in high temperature regions of gas turbines. Typically, the cooling features are cast on or within the component during manufacturing, although it is difficult to form most complex cooling features through currently available casting techniques.

Additionally, a surface microstructure of the cooling features formed through casting of the component is generally determined by the specific casting process. While varying process parameters of the casting process may vary the mechanical properties, modifying a surface structure usually includes machining or surface treating. However, for certain components, such as articles with internal cooling features, access to the inner surface of the article as well as the surface of the internal cooling features is highly limited. Due to the limited access, modifying the surface structure of the cooling features is difficult, time consuming, and expensive. Furthermore, it may not always be possible to reach each cooling feature or portion of the inner surface of the article during the machining process.

### BRIEF DESCRIPTION OF THE INVENTION

In an embodiment, an article includes a body portion having an inner surface and an outer surface, the inner surface defining an inner region, and at least one cooling feature positioned within the inner region. At least one of the inner surface of the body portion and the at least one cooling feature has a surface roughness of between about 100 microinches (about 2.54 microns) and about 3,000 microinches (about 76.2 microns).

In another embodiment, an article includes a body portion having an inner surface and an outer surface, the inner surface defining an inner region, and at least one cooling feature positioned within the inner region. The inner surface of the body portion and the at least one cooling feature include an additive manufacturing microstructure having a surface roughness of between about 100 microinches (about 2.54 microns) and about 3,000 microinches (about 76.2 microns), and the at least one cooling feature is selected from the group consisting of impingement targets, film holes, slots, pin banks, pin fins, turbulators, bumps, cooling holes, and combinations thereof.

In another embodiment, a method of forming an article includes manufacturing a body portion by an additive manufacturing technique, and manufacturing at least one cooling feature by the additive manufacturing technique. The additive manufacturing integrally forms a surface roughness of between about 100 microinches (about 2.54 microns) and about 3,000 microinches (about 76.2 microns) on at least one of an inner surface of the body portion and the at least one cooling feature.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a front perspective view of an article, according to an embodiment of the disclosure.

FIG. 2 is a section view of the article of FIG. 1, taken along the line 2-2, according to an embodiment of the disclosure.

FIG. 3 shows a perspective view of a section of the article of FIG. 1, taken along the line 2-2, according to an embodiment of the disclosure.

FIG. 4 is a section view of the article of FIG. 1, taken along the line 2-2, according to another embodiment of the disclosure.

FIG. 5 shows a perspective view of a section of the article of FIG. 1, taken along the line 2-2, according to an embodiment of the disclosure.

FIG. 6 is a magnified section view of a portion of the article, according to an embodiment of the disclosure.

FIG. 7 is a process view of a method of forming an article, according to an embodiment of the disclosure.

Wherever possible, the same reference numbers will be used throughout the drawings to represent the same parts.

### DETAILED DESCRIPTION OF THE INVENTION

Provided are an article and method of forming an article. Embodiments of the present disclosure, for example, in comparison to concepts failing to include one or more of the features disclosed herein, increase cooling effectiveness of cooling features, increase cooling efficiency, increase wall temperature consistency, decrease or eliminate over cool regions, increase heat transfer coefficients within an article, increase friction loss, maintain fluid flow with an increased number of slots, increase cooling surface area with decreased fluid flow, provide varied heat transfer within an article, provide increased control of article cooling, increase article life, facilitate use of increased system temperatures, increase system efficiency, provide increased article cooling with decreased cooling fluid, or a combination thereof.

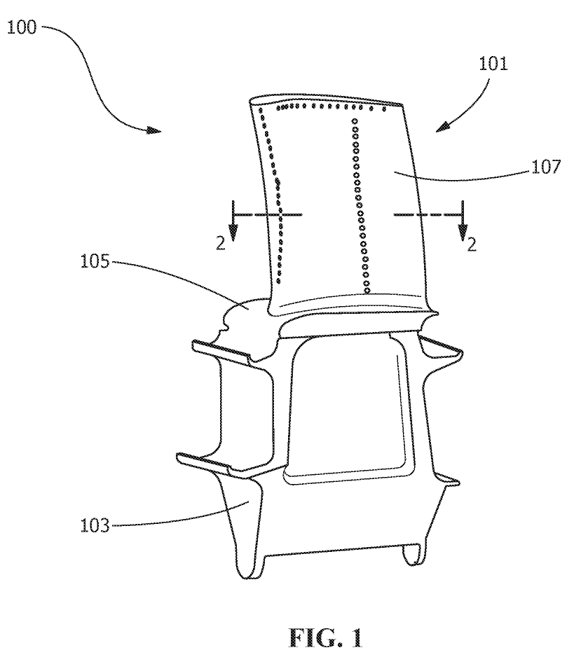

Referring to FIG. 1, in one embodiment, an article 100 includes a turbine bucket 101 or blade. The turbine bucket 101 has a root portion 103, a platform 105, and an airfoil portion 107. The root portion 103 is configured to secure the turbine bucket 101 within a turbine system, such as, for example, to a rotor wheel. Additionally, the root portion 103 is configured to receive a fluid from the turbine system and direct the fluid into the airfoil portion 107. Although described herein with regard to a turbine bucket, as will be appreciated by those skilled in the art, the article 100 is not so limited and may include any other article suitable for receiving a cooling fluid, such as, for example, a hollow component, a hot gas path component, a shroud, a nozzle, a vane, a combustor, a combustor transition piece, or a combination thereof.

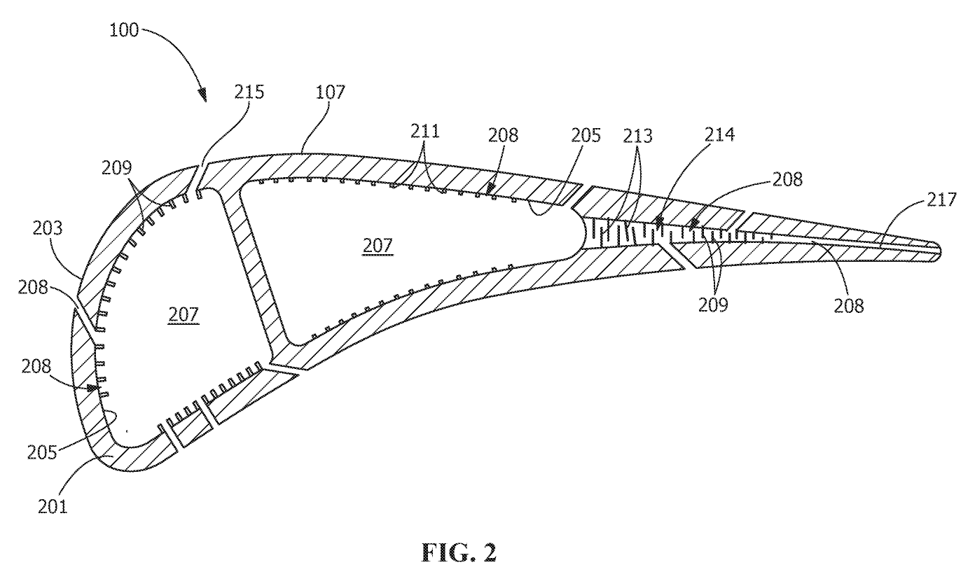

As illustrated in FIGS. 2-5, which show cross sections of the airfoil portion 107, the article 100 includes a body portion 201 having an outer surface 203, an inner surface 205 defining an inner region 207, and one or more cooling features 208 within the inner region 207. Suitable cooling features 208 include, but are not limited to, impingement targets, film holes, slots, pins, pin banks, pin fins, turbulators, bumps, cooling holes, dimples, fins, apertures, or any combination thereof.

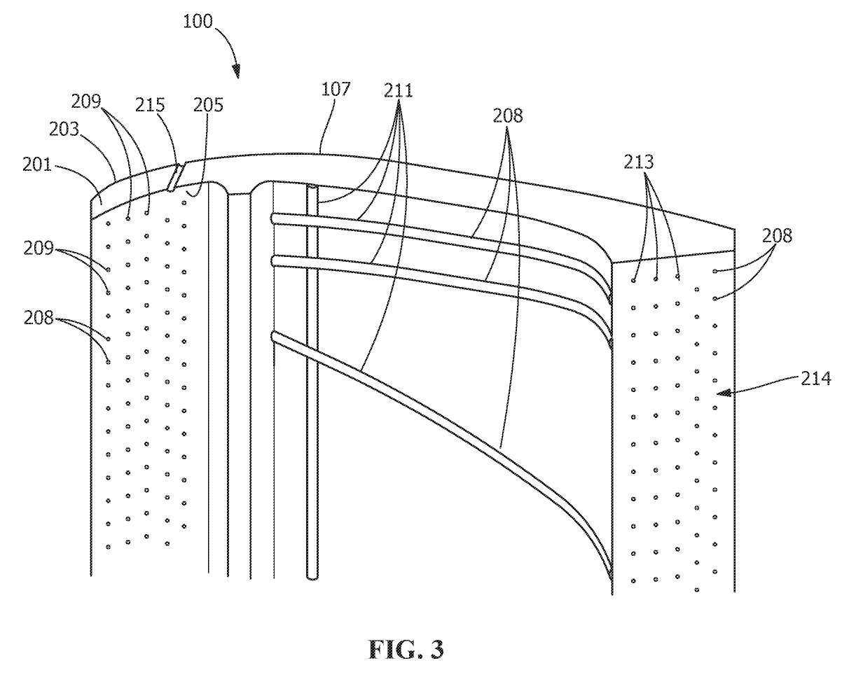

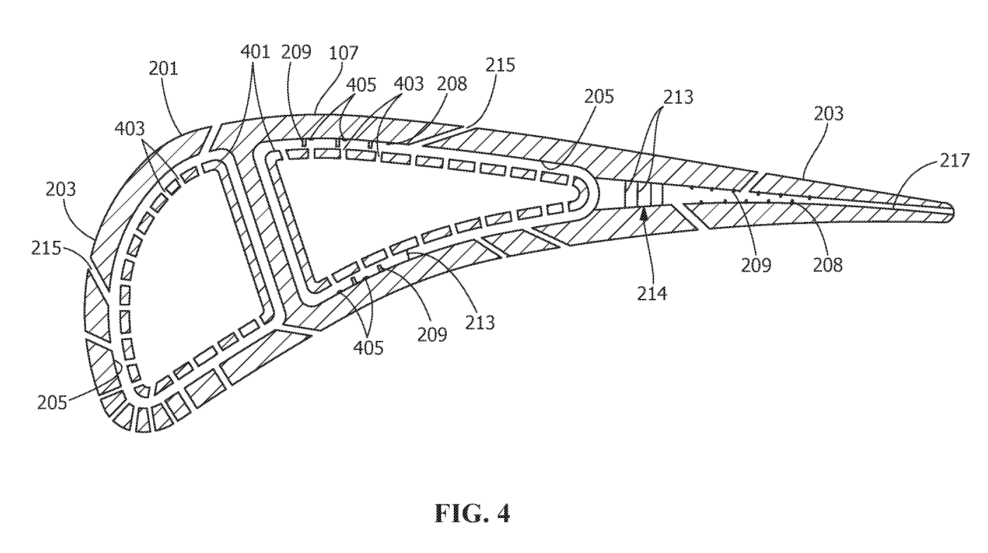

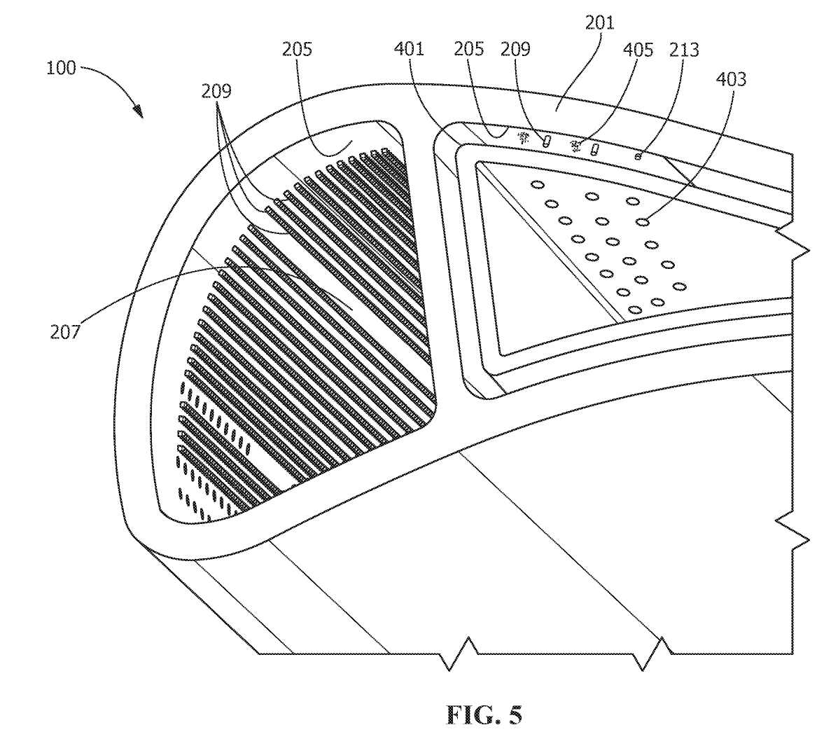

Each of the one or more cooling features 208 is formed on and/or in the body portion 201, or on and/or in an insert 401 (see FIGS. 4-5) that is arranged and disposed to be positioned within the article 100. For example, referring to FIGS. 2-3, in one embodiment, the cooling features 208 are formed on and/or in the body portion 201, and include bumps 209, turbulators 211, pins 213, film holes 215, and slots 217. The bumps 209 extend from the inner surface 205 of the body portion 201 into the inner region 207, while the pins 213 extend across or substantially across the inner region 207 from the inner surface 205 to an opposing surface within the inner region 207. Turning to FIGS. 4-5, in another embodiment, the cooling features 208 include the bumps 209, the pins 213, the pin bank 214, the film holes 215, the slots 217, and/or impingement targets 405 formed on and/or in the body portion 201, and apertures 403 formed in the insert 401.

In addition, each of the one or more cooling features 208 may be positioned in any suitable orientation on and/or in the body portion 201, the inner region 207, and/or the insert 401 to provide cooling of the article 100. For example, as illustrated in FIGS. 2-3, the bumps 209 and/or the pins 213 are positioned in any suitable arrangement and include any suitable geometric configuration for providing conductive cooling of the article 100, such as, but not limited to, aligned, staggered, regularly spaced, variably spaced, circular, semi-circular, square, irregular, or a combination thereof. In certain embodiments, a plurality of the pins 213 are positioned to form one or more pin banks 214 within the inner region 207, such as, but not limited to, within the trailing edge of the turbine bucket 101. In another example, the turbulators 211 extend along the inner surface 205 of the body portion 201 in any suitable configuration, such as, but not limited to, radially (FIGS. 2-3), horizontally (FIG. 3), angled from between 0 and 180 degrees relative to the radial direction (FIG. 3), or a combination thereof. Additionally, the turbulators 211 may be continuous and/or intermittently broken along the length of the inner surface 205. In another example, the film holes 215 and/or the slots 217 extending through the body portion 201 are arranged and disposed to fluidly connect the inner surface 205 to the outer surface 203, providing conductive cooling as a fluid passes therethrough. The film holes 215 and/or the slots 217 may also be arranged and disposed to provide film cooling of the outer surface 203. Referring to FIGS. 4-5, in a further example, the apertures 403 extending through the insert 401 are arranged and disposed to direct the cooling fluid towards the body portion 201, providing impingement cooling of the inner surface 205.

As will be appreciated by those skilled in the art, the cooling features 208 are not limited to the examples discussed above, and may include any other suitable cooling features or combination of cooling features. In one suitable combination, the one or more cooling features 208 include corresponding cooling features 208 formed on and/or in both the body portion 201 and the insert 401. For example, in one embodiment, as shown in FIG. 5, the insert 401 includes one or more of the apertures 403 formed therein, and the body portion 201 includes at least one corresponding impingement target 405 formed on the inner surface 205 thereof. Each of the impingement targets 405 is arranged and disposed relative to one of the apertures 403, such that the fluid directed through the apertures 403 contacts the impingement target 405 upon reaching the inner surface 205. Additionally or alternatively, one or more of the bumps 209 and/or pins 213 is formed on the inner surface 205, and extends from the body portion 201 towards the insert 401 (see FIGS. 4-5). After the fluid from the apertures 403 contacts the inner surface 205, it forms a post-impingement fluid. As the post-impingement fluid flows between the inner surface 205 and the insert 401 it passes over the bump(s) 209 and/or the pin(s) 213, which provide conductive cooling of the body portion 201.

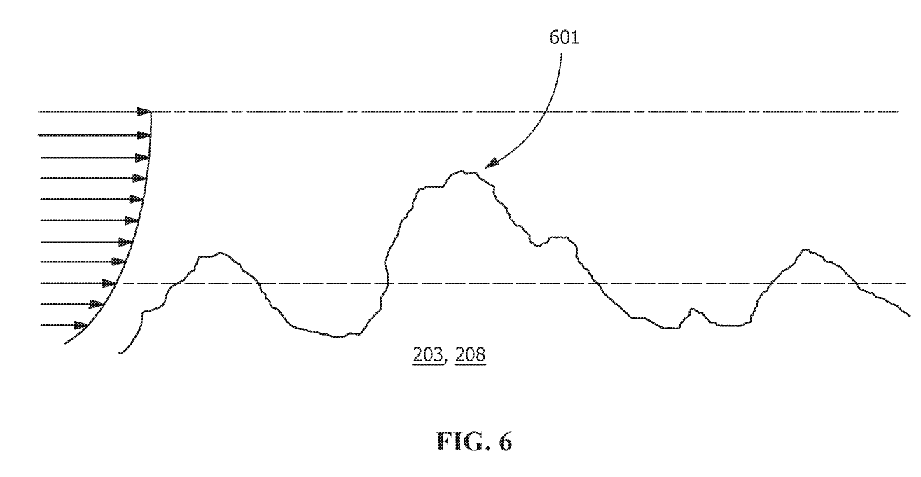

In each of the embodiments disclosed herein, the inner surface 205 and/or at least one of the cooling features 208 includes an integrally formed rough surface 601, an example of which is shown in FIG. 6. As used herein, the term “rough surface” includes any surface having an average surface roughness of at least about 100 microinches (about 2.54 microns), such as, but not limited to, between about 100 microinches (about 2.54 microns) and about 3,000 microinches (about 76.2 microns), between about 200 μin (about 5.08μ) and about 3,000 μin (about 76.2μ), between about 500 μin (about 12.7μ) and about 3,000 μin (about 76.2μ), between about 500 μin (about 12.7μ) and about 2,500 μin (about 63.5 μin), between about 1,000 μin (about 25.4μ) and about 2,000 μin (about 50.8μ), or any combination, sub-combination, range, or sub-range thereof.

The integrally formed rough surface 601 increases the heat transfer coefficient of the inner surface 205 and/or the cooling feature(s) 208 as compared to inner surfaces and/or cooling features without a rough surface. This increased heat transfer coefficient increases cooling efficiency of the article 100, which facilitates cooling of the article 100 with decreased cooling flow. Additionally or alternatively, the integrally formed rough surface 601 increases friction loss as compared to inner surfaces and/or cooling features without a rough surface. The increased friction loss decreases flow through the film holes 215, slots 217, and other openings in the article 100, permitting the formation of more openings in the article 100 without increasing fluid flow to the article 100. The formation of more openings in the article 100 increases the surface area available for cooling, which increases heat transfer, increases cooling efficiency, provides cooling of the article 100 with decreased cooling flow, increases engine efficiency, or a combination thereof.

In one embodiment, both the inner surface 205 and the cooling feature(s) 208 include the integrally formed rough surface 601 having the same or substantially the same surface roughness. In another embodiment, the surface roughness of the integrally formed rough surface 601 on the cooling feature(s) 208 differs from that of the inner surface 205. In a further embodiment, the surface roughness varies within the integrally formed rough surface 601 of the inner surface 205 and/or the cooling feature(s) 208.

The varying of the surface roughness varies the heat transfer coefficient within the article 100, providing increased control over cooling of the article 100. In one embodiment, the surface roughness of the integrally formed rough surface 601 is varied as a function of a heat load on the article 100, such as that from a hot gas path in a gas turbine. By varying the surface roughness as a function of the heat load, the integrally formed rough surface 601 increases a consistency of the temperature of the body portion 201, decreases or eliminates over cooling of the article 100, decreases or eliminates unnecessary heating of the cooling fluid, or a combination thereof. For example, the inner surface 205 on a pressure side of the airfoil 107, which has a comparatively lower heat load, may include a surface roughness of about 300 μin, while the inner surface 205 on the suction side of the airfoil 107, which has a comparatively higher heat load, may include a surface roughness of about 2,000 μin. The greater surface roughness on the suction side provides increased heat transfer as compared to the pressure side, facilitating increased cooling of the suction side and/or decreasing or eliminating over cooling of the pressure side. In another example, the surface roughness of the integrally formed rough surface 601 is varied from the inlet to the outlet of the slots 217 in the trailing edge of the airfoil 107. The varying surface roughness within the slots 217 increases the heat transfer coefficient of the slots 217 as the heat load increases and/or the temperature of the cooling fluid increases.

According to one or more of the embodiments disclosed herein, the inner surface 205 and/or the cooling feature(s) 208 having the rough surface 601 also have an additive manufacturing microstructure. For example, forming the inner surface 205 and/or the cooling feature(s) 208 having the rough surface 601 may include any suitable method of additive manufacturing. Suitable methods of additive manufacturing include, but are not limited to, direct metal laser melting (DMLM), direct metal laser sintering (DMLS), selective laser melting (SLM), selective laser sintering (SLS), electron beam melting (EBM), fused deposition modeling (FDM), any other additive manufacturing technique, or a combination thereof.

In one embodiment, the FDM method includes supplying a material to a nozzle, heating the nozzle, and extruding the material through the nozzle. The heating of the nozzle melts the material as the material passes through the nozzle. Upon extrusion of the material through the nozzle the material hardens, forming the body portion 201 and/or the one or more cooling features 208 having the integrally formed rough surface 601.

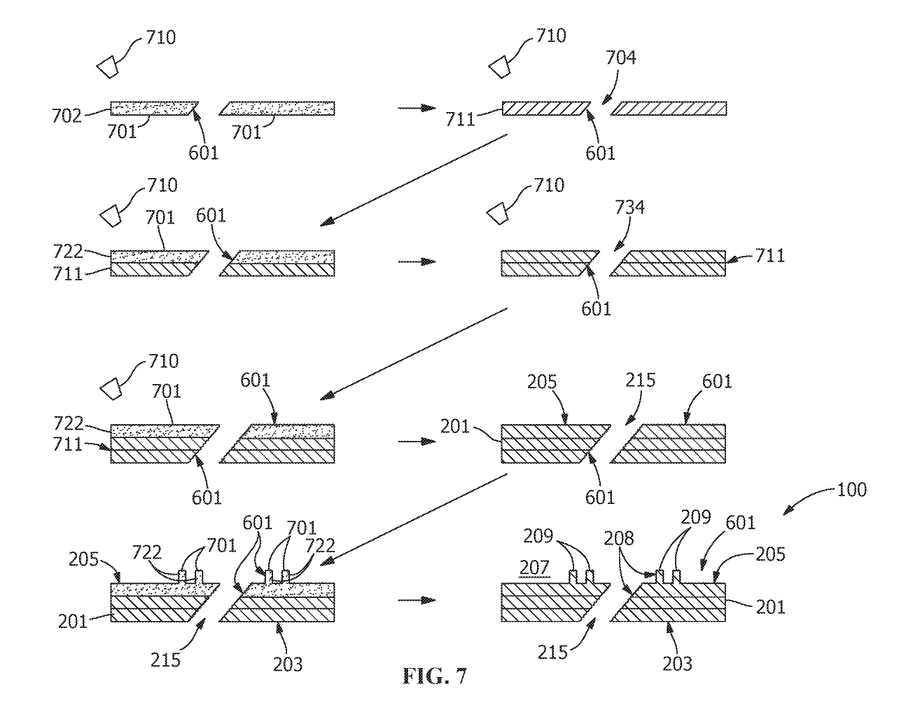

In another embodiment, as illustrated in FIG. 7, the DMLM method includes providing a metal alloy powder 701 and depositing the metal alloy powder 701 to form an initial powder layer 702. The initial powder layer 702 is then melted with a focused energy source 710, transforming the initial powder layer into a portion 711 of a component. Suitable focused energy sources include, but are not limited to, a laser device, an electron beam device, or a combination thereof. Next, the DMLM process includes sequentially depositing additional metal alloy powder 701 over the portion 711 of the component to form an additional layer 722 and melting the additional layer 722 with the focused energy source 710. The melting of the additional layer 722 joins the additional layer 722 to the previously formed portion 711, increasing a thickness of the portion 711 by the thickness of the additional layer 722. The steps of sequentially depositing the additional layer 722 of the metal alloy powder 701 and melting the additional layer 722 may then be repeated to form the final component. At each step of depositing the metal alloy powder 701, the corresponding initial powder layer 702 or additional layer 722 is formed with a predetermined geometry and/or thickness. Suitable geometries and/or thicknesses include, but are not limited to, those corresponding to the article 100, the body portion 201, one or more of the cooling features 208, the insert 401, and/or the integrally formed rough surface 601. When combined, the predetermined geometries and/or thicknesses of the initial powder layer 702 and the additional layer(s) 722 provide the final geometry and thickness of the final component.

Integrally forming the rough surface 601 during the additive manufacturing facilitates increased control over the average surface roughness and/or location of the rough surface 601 within the article 100. For example, in one embodiment, the depositing and/or melting of the metal alloy powder 701 is varied during the additive manufacturing process to increase or decrease the surface roughness in the corresponding portion of the article 100. In another embodiment, the integral forming of the rough surface 601 during additive manufacturing permits the formation of the rough surface 601 in portions of the article 100 that are not accessible by traditional manufacturing and/or machining techniques. In a further embodiment, the integrally formed rough surface 601 provides increased heat transfer and/or cooling of the article 100, as compared to other rough surfaces formed through machining and/or attachment to the article 100.

The final component formed by the additive manufacturing method includes any suitable net or near-net shape structure. As used herein “near-net shape” means that the component is formed very close to the final shape, not requiring significant traditional mechanical finishing techniques such as machining or grinding following the additive manufacturing. Additionally, as used herein “net shape” means that the component is formed in the final shape, requiring no traditional mechanical finishing techniques following the additive manufacturing. Suitable net or near-net shape structures include, but not limited to, the article 100, the body portion 201, the inner surface 205, the cooling feature(s) 208, the insert 401, the integrally formed rough surface 601, or a combination thereof. For example, although the final component is shown in FIG. 7 as the article 100 including the inner surface 205 and/or the cooling features 208 integrally formed with the body portion 201 in a single additive manufacturing process, as will be appreciated by those skilled in the art, the inner surface 205 and/or the cooling features 208 having the integrally formed rough surface 601 may be formed separate from and then attached to the body portion 201. Additionally, when formed separately, the inner surface 205 and/or cooling feature(s) 208 having the integrally formed rough surface 601 may be attached directly to the body portion 201 and/or the insert 401, or may be formed on an intermediate layer that is secured to the body portion 201 and/or the insert 401.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An article, comprising:
a body portion having an inner surface and an outer surface, the inner surface defining an inner region; and
at least one cooling feature positioned within the inner region;
wherein at least one of the inner surface of the body portion and the at least one cooling feature has a surface roughness of between about 100 microinches (about 2.54 microns) and about 3,000 microinches (about 76.2 microns).

2. The article of claim 1, wherein the at least one cooling feature is selected from the group consisting of impingement targets, film holes, slots, pin banks, pin fins, turbulators, bumps, cooling holes, and combinations thereof.

3. The article of claim 1, wherein the inner surface of the body portion and the at least one cooling feature have a surface roughness of between about 100 microinches (about 2.54 microns) and about 3,000 microinches (about 76.2 microns).

4. The article of claim 3, wherein the surface roughness of the inner surface of the body portion differs from the surface roughness of the at least one cooling feature.

5. The article of claim 1, wherein the surface roughness is varied within the article.

6. The article of claim 5, wherein the surface roughness is varied as a function of a heat load from a hot gas path.

7. The article of claim 1, wherein the surface roughness increases a heat transfer coefficient of the article.

8. The article of claim 1, wherein the surface roughness increases friction loss of the component.

9. The article of claim 1, wherein the at least one cooling feature is integral with the body portion.

10. The article of claim 1, wherein the at least one cooling feature is formed on an insert, the insert being arranged and disposed for positioning within the inner region of the body portion.

11. The article of claim 10, wherein the surface roughness of the inner surface of the body portion corresponds to an orientation of the at least one cooling feature formed on the insert.

12. The article of claim 10, further comprising at least one additional cooling feature formed in the body portion.

13. The article of claim 1, wherein at least one of the body portion and the at least one cooling feature include an additive manufacturing microstructure.

14. The article of claim 1, wherein the article is a gas turbine component.

15. The article of claim 14, wherein the gas turbine component is selected from the group consisting of an airfoil, a bucket, a nozzle, a shroud, a combustor, a combustor transition piece, and combinations thereof.

16. The article of claim 14, wherein the gas turbine component is an airfoil.

17. An article, comprising:
a body portion having an inner surface and an outer surface, the inner surface defining an inner region; and
at least one cooling feature positioned within the inner region;
wherein the inner surface of the body portion and the at least one cooling feature include an additive manufacturing microstructure having a surface roughness of between about 100 microinches (about 2.54 microns) and about 3,000 microinches (about 76.2 microns); and
wherein the at least one cooling feature is selected from the group consisting of impingement targets, film holes, trailing edge slots, pin banks, pin fins, turbulators, bumps, cooling holes, and combinations thereof.

18. A method of forming an article, the method comprising:
manufacturing a body portion by an additive manufacturing technique; and
manufacturing at least one cooling feature by the additive manufacturing technique;
wherein the additive manufacturing integrally forms a surface roughness of between about 100 microinches (about 2.54 microns) and about 3,000 microinches (about 76.2 microns) on at least one of an inner surface of the body portion and the at least one cooling feature.

19. The method of claim 18, wherein the additive manufacturing technique comprises:
distributing a first layer of a material to a selected region;
selectively laser melting the first layer;
distributing at least one additional layer of the material over the first layer;
selectively laser melting each of the at least one additional layers; and
forming the article from the material;
wherein the steps of distributing and selectively laser melting the material integrally form the surface roughness of between about 100 microinches (about 2.54 microns) and about 3,000 microinches (about 76.2 microns).

20. The method of claim 18, wherein the manufacturing of the at least one cooling feature is concurrent with the manufacturing of the body portion, integrally forming the at least one cooling feature with the body portion.
